(19) United States
(12) Patent Application Publication
(10) Pub. No.: US 2016/0004703 A1
(43) Pub. Date: Jan. 7, 2016

(54) METHODS FOR MODIFYING AND RANKING SEARCHES WITH ACTIONS BASED ON PRIOR SEARCH RESULTS AND ACTIONS

(71) Applicant: International Business Machines Corporation, Armonk, NY (US)

(72) Inventors: Srihari V. Angaluri, Raleigh, NC (US); Gary D. Cudak, Wake Forest, NC (US); Christopher J. Hardee, Raleigh, NC (US); Luke D. Remis, Raleigh, NC (US); Adam Roberts, Moncure, NC (US)

(21) Appl. No.: 14/827,581

(22) Filed: Aug. 17, 2015

Related U.S. Application Data
(63) Continuation of application No. 14/324,190, filed on Jul. 6, 2014.

(51) Int. Cl. G06F 17/30; G06F 3/0484; H04L 29/08

(52) U.S. Cl. CPC G06F 17/3053; H04L 67/02; G06F 3/0484

(57) ABSTRACT

Methods for modifying and ranking searches with actions based on prior search results and actions are disclosed herein. According to an aspect, a method comprises using at least one processor and memory determining an action associated with web content. Further, the method comprises receiving user input identifying search criteria. Further, the method, in response to determining that the search criteria is associated with the web content, comprises presenting search results associated with the search criteria and a user interface for initiating the action with respect to one or more of the search results.

### CROSS REFERENCE TO RELATED APPLICATION

This application is a continuation application of U.S. patent application Ser. No. 14/324,190, filed Jul. 6, 2014; the entire content of which is incorporated herein by reference in its entirety.

### BACKGROUND

1. Field of the Invention

The present invention is related to modified and ranking searches, and more specifically, to systems and methods for modifying and ranking searches with actions based on prior search results and actions.

2. Description of Related Art

A search engine is an information retrieval system that searches documents such as the text of web pages for keywords, and returns search results in the form of a listing of documents or links to websites where the keywords were found. Search engines work by matching a query, or request for information that includes keywords, against an index that typically has been created by the search engine. The index contains data that indicates the content of a large number of documents or websites and includes the keywords (or truncated versions of the keywords) as well as pointers to the locations of the keywords in each document. The index is searched for matches with the keywords, and these matches form the results of the search.

Search engines attempt to determine the relevance of each search result, and then to inform the searcher of the perceived degree of relevance of each search result. Various factors are used to determine this relevance, such as the frequency with which the keywords appear in the document, or the location in the document where the keywords appear (for example keywords in the title of a document might be deemed to be more important than keywords appearing near the end of the document). The intent of these ranking systems is to have the most relevant search results indicated at the top of the list of search results, where they are most likely to be visited by the searcher. However, the searcher must often further manipulate the search results to obtain the information, files, images or other information that the searcher is really interested in.

In view of the foregoing, there is a need for improved systems and methods for modifying and ranking searches with actions based on prior search results and actions.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for modifying and ranking searches with actions based on prior search results and actions. According to an aspect, a method includes determining an action associated with web content. Further, the method includes receiving user input identifying search criteria. Further, the method includes presenting search results associated with the search criteria and a user interface for initiating the action with respect to one or more of the search results in response to determining that the search criteria is associated with the web content.

### BRIEF DESCRIPTION OF THE SEVERAL VIEWS OF THE DRAWINGS

FIG. 1 is a block diagram of an example system for modifying and ranking searches with actions based on prior search results and actions in accordance with embodiments of the present invention;

FIG. 2 is a flowchart of an example method for modifying and ranking searches with actions based on prior search results and actions in accordance with embodiments of the present invention;

FIG. 3 is an example user interface for entering a search parameter and specifying a desired action associated with a search parameter in accordance with embodiments of the present invention;

FIG. 4 is an example user interface for entering a search parameter without specifying a desired action in accordance with embodiments of the present invention; and

FIG. 5 is an example user interface for entering a search parameter without specifying a desired action and allowing an auto-complete function to suggest biased search parameters based on previously stored searches and associated actions in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. In another example, a computing device may be a server or other computer and communicatively connected to other computing devices (e.g., handheld devices or computers) for data analysis. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

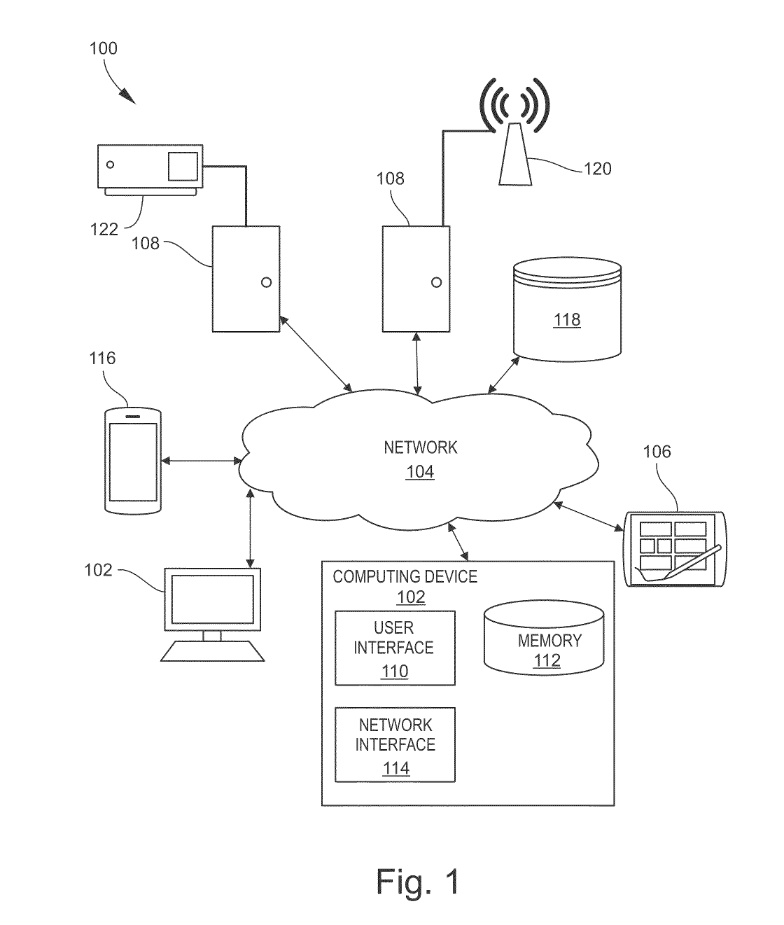

The presently disclosed invention is now described in more detail. FIG. 1 illustrates a block diagram of a system 100 according to embodiments of the present invention. The system 100 may be implemented in whole or in part in any suitable environment. The computing devices 102 may each be communicatively connected via a communications network 104, which may be any suitable local area network (LAN), either wireless (e.g., BLUETOOTH® communication technology) and/or wired. The computing device 102, a tablet device 106 in communication with one of the computing devices 102, and other components, not shown, may be configured to acquire data within the computing environment, to process the data, and to communicate the data to a centralized server 108. For example, the computing device 102 and its tablet device 106 may operate together to implement a search analysis function and to communicate data related thereto to the server 108 using a user interface 110.

The components of the system 100 may each include hardware, software, firmware, or combinations thereof. For example, software residing in memory of a respective component may include instructions implemented by a processor for carrying out functions disclosed herein. The computing device 102 may also include memory 112. The computing device 102 may also include a suitable network interface 114 for communicating with the network 104. The system 100 may also include a smart phone device 116 configured with functionality similar to the tablet device 106. The system 100 may also include a database 118 for storage of search inquiries, web sites and other similar data. Further, for example, the server 108 may be connected to the computing devices 102 via the network 104 or via a wireless network 120.

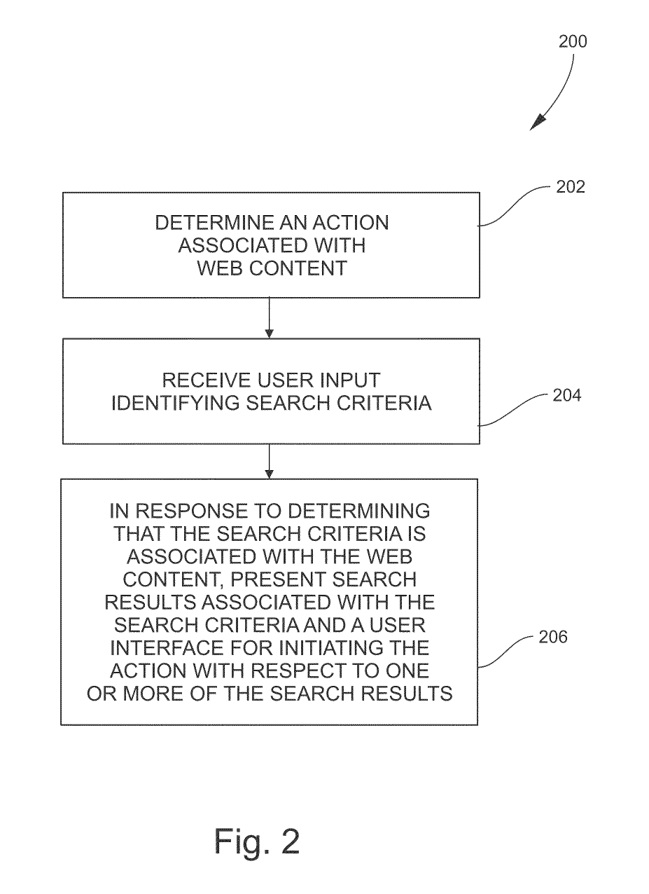

FIG. 2 is a flowchart of an example method 200 for modifying and ranking searches with actions based on web content, prior search results and associated actions in accordance with embodiments of the present invention. It is noted that reference is made to FIG. 1 as implementing the example method described in FIG. 2, although it should be understood that any suitably configured system can implement the method of FIG. 2.

With continued reference to FIG. 2, the method 200 includes determining 202 an action associated with web content. The method 200 may track a user's final actions based upon receiving the web content associated with prior search results. As users utilize a search engine, data associated with one or more actions taken by the users following receiving the web content and prior search results may be collected and stored in a database 118. The database 118 for storing the collected data including the actions taken by a user may be local to a computing device 102 used by the user or remotely located and in communication with the computing device 102 via a wired 104 or wireless network 120. Further, the database may store actions taken by a user, a plurality of users or based on actions taken on the computing device 102 or a set of particular computing devices 102.

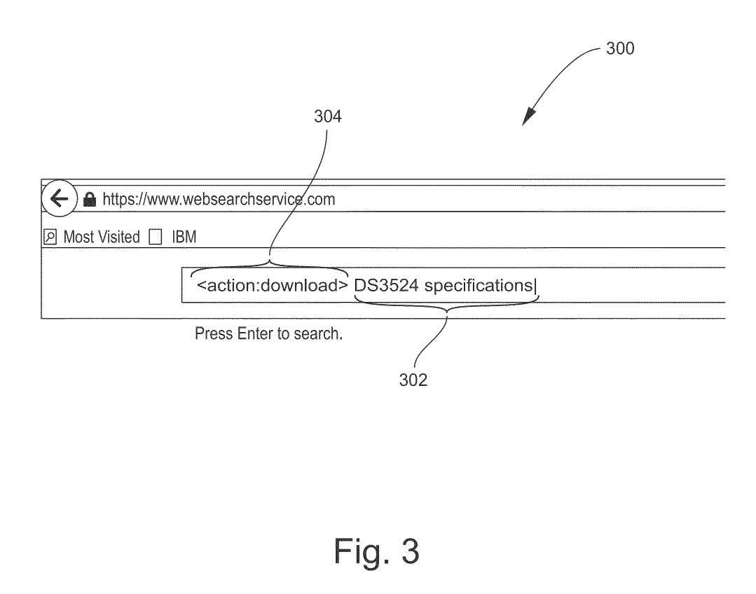

With continued reference to FIG. 2, the method 200 may include receiving 204 user input identifying search criteria. The computing device 102 may provide a user interface as described in the examples of FIGS. 3-5 for receiving 204 and identifying search criteria. Utilizing the received search criteria from the user, the computing device 102 may be configured to initiate a search. The computing device 102 may be configured to transmit the search criteria via the network 104 to other computing devices 102, servers 108, or other similarly configured devices. The search criteria may be transmitted to a server of any suitable search engine.

With continued reference to FIG. 2, the method 200 may, in response to determining that the search criteria is associated with the web content, present 206 search results associated with the search criteria and a user interface for initiating the action with respect to one or more of the search results. As will be further disclosed in FIGS. 3-5, the search results may be a biased list of search recommendations. The search results may also have an associated list of actions. The biased list of search results recommended may be based on stored results of tracked user-implemented actions associated with web content. As previously discussed above, users may utilize a search engine, data regarding the actions taken or implemented by users associated with web content may be collected and stored in a database 118. The actions taken or implemented by users may include downloading, bookmarking, copying and pasting, as non-limiting examples. The actions tracked and stored may also be a series of actions, for example, clicking on a series of links. Clicking on a common or similar links repeated by several users may indicate a pattern that should be associated with an action and may be subsequently presented in a list of search results as described herein. The biased list of recommended or suggested search results may be generated, sorted, prioritized or otherwise provided based on the previously tracked actions by the user or a plurality of users.

The method 200 may alternatively further include generating a biased list of search results presented in a dynamic user interface, such as a drop down user interface suggesting search parameters and/or suggested actions associated with the search parameters. The biased list of search results presented in the user interface may have at least one user implementable action associated with each of the search results in the biased list. The user implementable actions may include, as an example, downloading, bookmarking, calling, emailing, linking, copying and pasting. The user implementable actions are based on the determined 202 actions associated with web content. The biased list of search results presented may also be based on search criteria or parameters input by the user in the user interface. The search criteria input by the user and used for obtaining the search results may or may not be the presented search parameters generated and presented in the interface as described in step 206.

FIG. 3 is an example user interface 300 for entering at least one search parameter 302 and a user specified desired action 304 associated with the search parameter 302 in accordance with embodiments of the present invention. In this example, the user interface is a portion of a display. The user interface 300 may be configured to allow the user to input the user specified desired action 304 as the user action. The user specified desired action 304 may be input in the same user interface 300 as the search parameter 302. The user specified desired action 304 may be input by a keyboard coupled to the computing device 102, as an example. Alternatively, the user specified desired action 304 may be input via a check box, drop down, radio button, or the like (not shown) located on the user interface 300 and associated with the search parameter 302. The user specified desired action 304, similar to the user-implemented action described above, may include downloading, bookmarking, calling, emailing, linking, copying and pasting, as an example. Additionally, the list of generated search results may be further modified based on the user specified desired action 304.

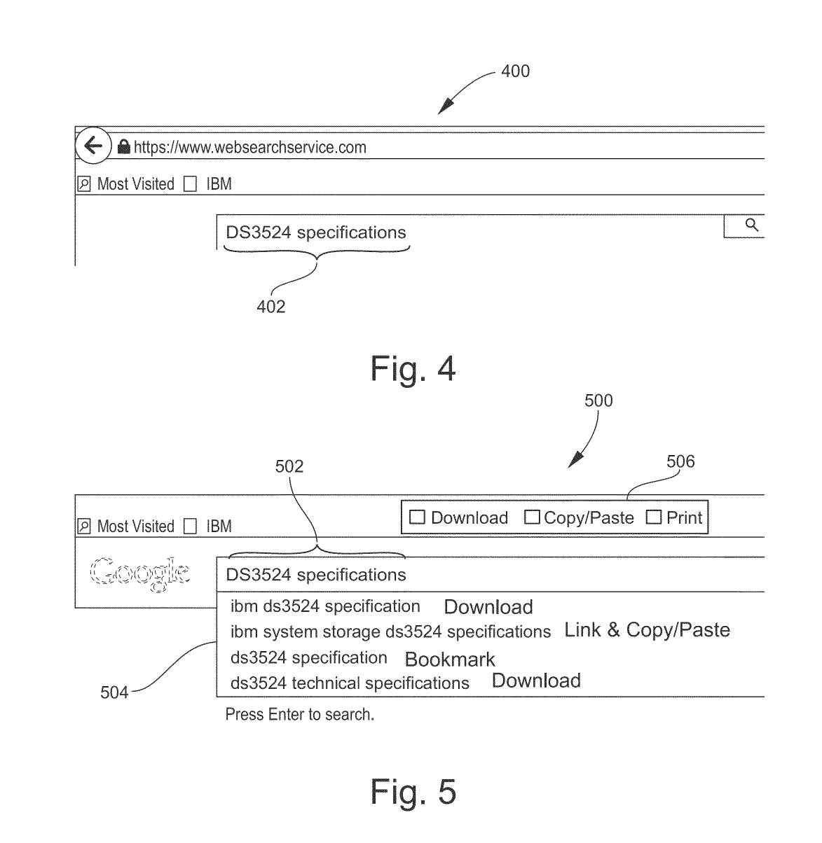

FIG. 4 is an example user interface 400 for entering search parameter 402 without specifying a desired action in accordance with embodiments of the present invention. In this example, the user interface is a portion of a display. The user interface 400 may allow for the user to input the search parameter 402 in free form via a keyboard, as an example, or input based on a suggested search parameter 402. The search parameter 402 may be suggested based on manually entered or pre-programmed search criteria. In response to receiving the search parameter 402, the system 100 may be configured to present search parameters as will be described in FIG. 5 based on the tracking or determining the action associate with web content. The presented search parameters are dynamically listed based upon the entering of the second set of search criteria 402.

FIG. 5 is an example user interface 500 for entering a search parameter 502 without also entering or specifying a desired action. In this example, the user interface is a portion of a display. The system 100 may be configured with an auto-complete function suggesting search parameters 504 based on previously stored searches and associated actions in accordance with embodiments of the present invention. As described above the system 100 tracks or determines actions associated with web content. Based on the tracked or determined actions the system 100 may be configured to suggest or present search parameters 504. The presented search parameters 504 may be dynamically presented, such that, the list may change the presented search parameters 504 as the entered search parameters 502 are input by the user. The presented search parameters 504 may also be a biased list according to other algorithms as determined by the system 100. The biased list of presented search parameters 504 may be determined by frequency of the chosen search parameter by the user. The biased list of presented search parameters 504 may also be determined based on a user configured setting (not shown) prioritizing one type of action over another type of action, such as, a download action over a copy and paste action, for example. The user configured setting may be saved locally to the computing device 102 or in the database 118 on the system 100. The user configured setting may also be manually or programmatically set.

With continued reference to FIG. 5, the biased list of presented search parameters 504 may also be determined based on previously executed applications on the computing device 102. For example, if a user was using a word processing program a few minutes prior to conducting a search, the system 100 may be configured to bias the suggested search parameters template or font downloads. As an additional example, if the user was attempting to add a printer to the computing device 102 configuration, the suggested search parameters may include a link and download action associated with the printer manufacturer's support website. Alternatively, a tree or path may be displayed, instead of or in addition to the presented search parameters 504. The tree or path may show the path of link clicks necessary or suggested to achieve the desired action. The tree or path may be a weighted or biased description in a similar fashion to the list of presented search parameters 504 above. Alternatively, a check box 506 may be provided in the user interface 500. The check box 506 may be used to bias or determine either the presented search parameters 504 or the resulting list of search results. The check box 506 may also provide a filtering function for the results presented.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
using at least one processor and memory for:
determining an action associated with web content;
receiving user input identifying search criteria;
determining whether the search criteria is associated with the web content; and
in response to determining that the search criteria is associated with the web content, presenting search results associated with the search criteria and a user interface for initiating the action with respect to one or more of the search results.

2. The method of claim 1, wherein determining an action comprises one of:
downloading a file from the web content;
initiating contact with an entity identified in the web content;
copying a file from the web content;
linking to data in the web content; and
bookmarking data in the web content.

3. The method of claim 1, wherein determining an action comprises tracking multiple actions implemented by a user subsequent to presentation of the web content.

4. The method of claim 1, further comprising determining the search results based on the identified search criteria.

5. The method of claim 4, wherein determining the search results comprises biasing presentation of the search results based on the action.

6. The method of claim 1, wherein initiating the action comprises one of:
downloading a file from the web content;
initiating contact with an entity identified in the web content;
copying a file from the web content;
linking to data in the web content; and
bookmarking data in the web content.

7. The method of claim 1, further comprising presenting a user interface for identification of the action.

8. The method of claim 1, further comprising receiving user selection for initiating the action with respect to the one or more search results.

9. The method of claim 8, further comprising implementing the action with respect to the one or more search results in response to receipt of the user selection.

10. The method of claim 1, further comprising ranking the search results based on the search criteria and the action.
